(19) United States
(12) Patent Application Publication
(10) Pub. No.: US 2024/0361434 A1
(43) Pub. Date: Oct. 31, 2024

(54) Multi-beam scanning systems

(71) Applicant: LYTE AI, INC., Mountain View, CA (US)

(72) Inventors: Arman Hajati, San Carlos, CA (US); Yuval Gerson, Sunnyvale, CA (US); Alexander Shpunt, Saratoga, CA (US)

(21) Appl. No.: 18/685,236

(22) PCT Filed: Sep. 1, 2022
(86) PCT No.: PCT/US2022/042281

§ 371 Date: Feb. 21, 2024

Related U.S. Application Data
(60) Provisional application No. 63/240,012, filed on Sep. 2, 2021.

(51) Int. Cl. G01S 7/481; G01S 7/499

(52) U.S. Cl. CPC G01S 7/4811; G01S 7/4817; G01S 7/499

(57) ABSTRACT

An optoelectronic device (28, 130) includes an array (32, 152) of optical transceiver cells (34, 90, 162) including respective optical transducers (36, 134, 164) configured to couple optical radiation between the transceiver cells and a target through respective optical apertures defined by the optical transducers. A tunable radiation source (22, 210, 240) outputs coherent radiation while tuning a wavelength of the coherent radiation over a selected range. An optical distribution network (38) conveys the coherent radiation from the radiation source to the optical transceiver cells for transmission via the optical transducers toward the target. Projection optics (44, 140, 154) project the optical apertures onto respective fields of view on the target, and include a dispersive element (148, 156), which shifts the fields of view across the target responsively to the tuning of the wavelength.

### CROSS-REFERENCE TO RELATED APPLICATIONS

This application claims the benefit of U.S. Provisional Patent Application 63/240,012, filed Sep. 2, 2021. This application is related to PCT Patent Application PCT/US2022/40526 and to PCT Patent Application PCT/US2022/40527, both filed Aug. 17, 2022. The disclosures of all these related applications are incorporated herein by reference.

### FIELD OF THE INVENTION

The present invention relates generally to systems and methods for optical sensing, and particularly to integrated optical sensing devices.

### BACKGROUND

In many optical sensing applications, multiple points on a target are irradiated by an optical beam or beams, and the reflected radiation from each point is processed to analyze properties of the target. In some applications, such as optical coherence tomography (OCT) and continuous-wave (CW) LiDAR, a coherent beam is transmitted toward the target, and the reflected radiation is sensed and processed coherently with the transmitted radiation. To sense the properties of the target with high resolution, the transmitted beam may be scanned over the target area, or an array of multiple beams may be transmitted and sensed simultaneously using an array of receivers.

The terms “optical,” “light,” and “optical radiation,” as used in the present description and in the claims, refer to electromagnetic radiation in any of the visible, infrared, and ultraviolet spectral ranges.

### SUMMARY

Embodiments of the present invention that are described hereinbelow provide improved systems, devices, and methods for optical sensing.

There is therefore provided, in accordance with an embodiment of the invention, an optoelectronic device, which includes an array of optical transceiver cells including respective optical transducers configured to couple optical radiation between the transceiver cells and a target through respective optical apertures defined by the optical transducers. A tunable radiation source is configured to output coherent radiation while tuning a wavelength of the coherent radiation over a selected range. An optical distribution network is coupled to convey the coherent radiation from the radiation source to the optical transceiver cells for transmission via the optical transducers toward the target. Projection optics are configured to project the optical apertures onto respective fields of view on the target, and which include a dispersive element, which shifts the fields of view across the target responsively to the tuning of the wavelength.

In some embodiments, the device includes a planar substrate, wherein the optical transceiver cells are disposed on the substrate, and the optical distribution network includes multiple waveguides disposed on the substrate. In a disclosed embodiment, the optical distribution network includes optical switches, and the device includes a controller, which is configured to actuate the switches so as to select different subsets of the optical transceiver cells that are to receive the coherent radiation from the waveguides. Additionally or alternatively, the waveguides are configured as optical buses, and the optical transceiver cells include respective taps coupled to extract a portion of the coherent radiation propagating through the optical buses. In some embodiments, the optical transducers include grating couplers disposed on a surface of the substrate. In other embodiments, the optical transducers include edge couplers disposed along an edge of the substrate.

In a disclosed embodiment, the optical transceiver cells include respective receivers, which are coupled to mix a part of the coherent radiation received from the optical distribution network with the optical radiation received from the target by the respective optical transducers and to output electrical signals responsively to the mixed radiation

In some embodiments, the dispersive element includes a prism.

In one embodiment, the optical transducers are arranged along one or more parallel rows in the array, and wherein the dispersive element is configured to shift the fields of view in a scan direction perpendicular to the rows responsively to the scanning of the wavelength. Additionally or alternatively, the dispersive element is configured to shift the fields of view across the target in a first direction responsively to the scanning of the wavelength, and the device includes an optomechanical scanner, which is configured to shift the fields of view across the target in a second direction, different from the first direction.

In some embodiments, the tunable radiation source is configured to output the coherent radiation at multiple wavelengths simultaneously, whereby the dispersive element shifts the fields of view at each of the multiple wavelengths by a different, respective angular shift. In some of these embodiments, the optical distribution network includes one or more optical switches, which are configured to direct the coherent radiation at the multiple wavelengths to different, respective sets of the transceiver cells. In one embodiment, the one or more optical switches are configured to cycle the multiple wavelengths through the sets of the transceiver cells so that each of the transceiver cells receives and transmits the coherent radiation at two or more different wavelengths at different, respective times. Additionally or alternatively, the tunable radiation source includes multiple laser sources, wherein each of the laser sources outputs a respective beam of the coherent radiation at a respective one of the multiple wavelengths. Further additionally or alternatively, the tunable radiation source is configured to generate a frequency comb including the multiple wavelengths in a single beam.

There is also provided, in accordance with an embodiment of the invention, an optoelectronic device, including a beamsplitter, which includes an optical surface that selectively reflects optical radiation having a first optical property while selectively transmitting the optical radiation having a second optical property, different from the first optical property. A first photonic integrated circuit (PIC) is disposed on a first side of the beamsplitter and includes a first array of first optical cells including respective first optical transducers, which are configured to couple first optical radiation between the first optical cells and a target by reflection from the optical surface. A second photonic integrated circuit (PIC) is disposed on a second side of the beamsplitter and includes a second array of second optical cells including respective second optical transducers, which are configured to couple second optical radiation between the second optical cells and the target by transmission through the optical surface.

In some embodiments, the optical surface is polarization-selective, such that the optical radiation having a first linear polarization is transmitted through the optical surface, while the optical radiation having a second linear polarization, perpendicular to the first linear polarization, is reflected from the optical surface. In one embodiment, the first optical transducers are configured for coupling the optical radiation having the first linear polarization between the beamsplitter and the first PIC, while the second optical transducers are configured for coupling the optical radiation having the second linear polarization between the beamsplitter and the second PIC. In another embodiment, the first and second optical transducers are both configured for coupling the optical radiation having the same one of the first and second linear polarizations into and out of the first and second PICs, respectively, and the device includes a half-wave rotator disposed between the beamsplitter and one of the first and second PICs.

In an alternative embodiment, one of the first and second arrays includes optical transmitter cells, which are configured transmit polarized coherent radiation toward a target, while the other of the first and second arrays includes optical receiver cells, which are configured to receive the optical radiation reflected from the target, and the device includes a quarter-wave rotator disposed between the beamsplitter and the target.

In other embodiments, the optical surface is wavelength-selective, such that the optical radiation having in a first wavelength range is transmitted through the optical surface, while the optical radiation having a second in a second wavelength range, different from the first wavelength range, is reflected from the optical surface.

In some embodiments, the beamsplitter includes multiple optical surfaces, which selectively reflect and transmit the optical radiation toward three or more different sides of the beamsplitter, and the device includes at least a third PIC, which is disposed on a third side of the beamsplitter.

In some embodiments, the first and second PICs include respective first and second substrates, on which the first and second optical cells are respectively disposed, and the first and second optical transducers include grating couplers disposed on respective surfaces of the first and second substrates. Alternatively, the first and second optical transducers include edge couplers disposed along respective edges of the first and second substrates.

In some embodiments, both the first and second optical cells include transceiver cells, which are configured to transmit coherent radiation via the first and second optical transducers toward a target, and to receive the optical radiation from the target via the first and second optical transducers and to output electrical signals responsively to the received optical radiation.

There is additionally provided, in accordance with an embodiment of the invention, an optoelectronic device, including at least one planar substrate and an array of optical transceiver cells disposed on the at least one substrate. Each transceiver cell includes a first optical transducer configured to transmit outgoing optical radiation of a first linear polarization along a first axis and a second optical transducer configured to receive incoming optical radiation of a second linear polarization, perpendicular to the first linear polarization, along a second axis, which is displaced transversely relative to the first axis. A birefringent plate has a first side disposed in proximity to the at least one substrate so as to intercept the first and second axes and to deflect the optical radiation of one of the first and second linear polarizations so as to align the axes of the outgoing and incoming optical radiation at a second side of the birefringent plate.

In one embodiment, the optical transducers include grating couplers disposed on a surface of the substrate.

In other embodiments, the optical transducers include edge couplers disposed along an edge of the substrate. In one such embodiment, the birefringent plate includes an internal reflecting surface, which is configured to turn the first and second axes in a direction perpendicular to the at least one substrate.

There is further provided, in accordance with an embodiment of the invention, a method for optical sensing, which includes providing an array of optical transceiver cells including respective optical transducers configured to couple optical radiation between the transceiver cells and a target through respective optical apertures defined by the optical transducers. Coherent radiation is conveyed from a tunable source of coherent radiation via an optical distribution network to the optical transceiver cells for transmission via the optical transducers toward the target. A wavelength of the coherent radiation is tuned over a selected range. The optical apertures are projected onto respective fields of view on the target through a dispersive element, which shifts the fields of view across the target responsively to the tuning of the wavelength.

There is moreover provided, in accordance with an embodiment of the invention, a method for optical sensing, which includes providing a beamsplitter, including an optical surface that selectively reflects optical radiation having a first optical property while selectively transmitting the optical radiation having a second optical property, different from the first optical property. A first photonic integrated circuit (PIC), including a first array of first optical cells including respective first optical transducers, is mounted on a first side of the beamsplitter so that the first optical transducers couple first optical radiation between the first optical cells and a target by reflection from the optical surface. A second photonic integrated circuit (PIC), including a second array of second optical cells including respective second optical transducers, is mounted on a second side of the beamsplitter so that the second optical transducers couple second optical radiation between the second optical cells and the target by transmission through the optical surface.

There is furthermore provided, in accordance with an embodiment of the invention, a method for sensing, which includes providing an array of optical transceiver cells disposed on at least one substrate. Each transceiver cell includes a first optical transducer configured to transmit outgoing optical radiation of a first linear polarization along a first axis and a second optical transducer configured to receive incoming optical radiation of a second linear polarization, perpendicular to the first linear polarization, along a second axis, which is displaced transversely relative to the first axis. A first side of a birefringent plate is positioned in proximity to the at least one substrate so as to intercept the first and second axes and to deflect the optical radiation of one of the first and second linear polarizations so as to align the axes of the outgoing and incoming optical radiation at a second side of the birefringent plate.

There is also provided, in accordance with an embodiment of the invention, an optoelectronic apparatus, which includes a sensing device, including a planar substrate and an array of sensing cells disposed on the substrate. The sensing cells include at least first and second sets of the sensing cells including respectively first and second optical transducers of first and second types, which are respectively configured to couple optical radiation having different first and second optical characteristics between the first and second sets of the sensing cells and a target, thereby defining first and second optical apertures of the sensing cells in the first and second sets, respectively. A scanner is configured to scan the optical apertures across the target so that the optical apertures are projected successively onto respective sequences of multiple locations on the target, and at least one of the first optical apertures and at least one of the second optical apertures are projected onto each of the multiple locations at different times.

In some embodiments, the at least first and second sets of the sensing cells include three or more sets of the sensing cells, including at least three different types of the optical transducers.

In some embodiments, the first optical transducers are configured to couple the optical radiation having a first linear polarization, while the second optical transducers are configured to couple the optical radiation having a second linear polarization, orthogonal to the first linear polarization. Additionally or alternatively, the first optical transducers are configured to couple the optical radiation in a first wavelength band, while the second optical transducers are configured to couple the optical radiation in a second wavelength band, different from the first wavelength band. Further additionally or alternatively, the first and second sets of the sensing cells are configured to apply different, first and second sensing modalities to the optical radiation coupled from the target to the sensing cells by the first and second optical transducers.

In one embodiment, the scanner is configured to vary a density of the locations onto which the optical apertures are projected over different areas of the target. Additionally or alternatively, the apparatus includes a controller, which is configured to actuate the sensing cells selectively as the optical apertures are scanned across the target so as to vary a density of the locations onto which the optical apertures are projected over different areas of the target.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an optical sensing system, in accordance with an embodiment of the invention;

FIG. 2 is a block diagram that schematically shows details of an optical transceiver cell, in accordance with an embodiment of the invention;

FIG. 3A is a schematic pictorial view of an optical sensing system, in accordance with an embodiment of the invention;

FIG. 3B is a schematic sectional view of the optical sensing system of FIG. 3A;

FIG. 3C is a schematic frontal view showing details of a coupling arrangement used in the optical sensing system of FIG. 3A, in accordance with an embodiment of the invention;

FIG. 4A is a schematic pictorial view of an optical sensing system, in accordance with another embodiment of the invention;

FIG. 4B is a schematic sectional view of the optical sensing system of FIG. 4A;

FIG. 4C is a schematic frontal view showing details of an optical transceiver array used in the optical sensing system of FIG. 4A, in accordance with an embodiment of the invention;

FIGS. 5A, 5B, 5C and 5D are schematic frontal views of scan patterns projected onto a target by an optical sensing system, in accordance with an embodiment of the invention;

FIGS. 6A, 6B, 6C, 6D, 6E and 6F are schematic frontal views of scan patterns projected onto a target by an optical sensing system, in accordance with another embodiment of the invention;

FIG. 7 is a block diagram that schematically illustrates a multi-wavelength core transceiver engine, in accordance with an embodiment of the invention;

FIGS. 8A, 8B, 8C, 8D, 8E and 8F are schematic frontal views of scan patterns projected onto a target, in accordance with an embodiment of the invention;

FIG. 9A is a block diagram that schematically shows elements of the core transceiver engine, in accordance with an embodiment of the invention;

FIG. 9B is a spectral plot showing a frequency comb generated by the core transceiver engine of FIG. 9A, in accordance with an embodiment of the invention;

FIG. 10 is a schematic side view of an optoelectronic device, in accordance with an embodiment of the invention;

FIG. 11 is a schematic side view of an optoelectronic device, in accordance with another embodiment of the invention;

FIG. 12 is a schematic side view of an optoelectronic device, in accordance with yet another embodiment of the invention;

FIG. 13 is a schematic side view of an optoelectronic device, in accordance with an alternative embodiment of the invention;

FIG. 14A is a schematic pictorial view of an optoelectronic device, in accordance with an embodiment of the invention;

FIG. 14B is a schematic sectional view of the optoelectronic device of FIG. 14A;

FIG. 15A is a schematic pictorial view of an optoelectronic device, in accordance with another embodiment of the invention;

FIG. 15B is a schematic sectional view of the optoelectronic device of FIG. 15A;

FIG. 16A is a schematic top view of an optoelectronic device, in accordance with a further embodiment of the invention;

FIG. 16B is a schematic sectional view of the optoelectronic device of FIG. 16A;

FIG. 17A is a schematic pictorial view of an optical sensing system, in accordance with an embodiment of the invention; and

FIG. 17B is a schematic frontal view of an optical transceiver array used in the optical sensing system of FIG. 17A, in accordance with an embodiment of the invention.

### DETAILED DESCRIPTION OF EMBODIMENTS

### Overview

As noted earlier, in coherent sensing applications, such as OCT and CW LiDAR, a coherent beam is transmitted toward a target, and the reflected radiation is sensed and processed coherently with the transmitted radiation. To sense the properties of the target with high resolution, the area of interest should be probed densely. Arrays of transmitters and receivers are useful for this purpose, but their resolution is limited by the pitches of the arrays, which are, in turn, limited by the sizes of the transmitters and receivers themselves. The above-mentioned PCT patent applications describe solutions in which the sensing resolution of an array is enhanced by scanning the fields of view of the sensing cells in the array, for example by an optomechanical element such as a rotating mirror or translation of the scanning optics or the array.

Embodiments of the present invention that are described herein expand on these solutions by providing sensing devices and systems in which the sensing resolution of a coherent sensing array is enhanced without requiring the use of any moving parts. These embodiments are useful in reducing the size and improving the reliability of the sensing system. Some of these embodiments use a tunable radiation source to provide coherent radiation for transmission by the cells in an array, together with a dispersive element in the optics that project the radiation toward a target. Other embodiments use novel beamsplitting and beam-combining arrangements to overlap or interleave the fields of view of multiple arrays of cells.

In the disclosed embodiments, the sensing cells themselves are typically produced using photonic integrated circuit (PIC) technology. These cells are designed to meet application requirements, such as the sensing mode and sensitivity, the mode of input/output coupling (for example, vertically or through the edge of the chip, via a grating or via a mirror), and wavelength characteristics (spectral range, and single- or multiple-wavelength sensing). In some embodiments, the arrays comprise transceiver cells, wherein each cell includes optical and optoelectronic components both for transmitting a beam of radiation and for receiving and detecting reflected radiation, along with ancillary electronics. In other embodiments, cells may comprise components only for transmitting or only for receiving and detection of radiation.

A number of sensing cell arrays and scanning systems are described below by way of example. The principles of the present embodiments, however, may be readily extended and adapted to other applications involving multi-beam sensing. Furthermore, although the disclosed embodiments are directed to optical sensing, in the visible, infrared, or ultraviolet range, the principles of the present invention may alternatively be applied, mutatis mutandis, in other spectral ranges, such as microwave and millimeter-wave radiation. All such alternative applications are considered to be within the scope of the present invention.

### Transceiver Arrays With Spectral Scanning

When a beam of optical radiation with tunable wavelength passes through a dispersive element, such as a prism or a diffraction grating (which may be either reflective or transmissive), the deflection angle of the beam will change as the wavelength of the optical radiation is tuned. In the present embodiments, this phenomenon is used to scan the beam transversely across a target and thus probe properties of the target as a function of position. As long as the properties are wavelength-independent, such as the target range and/or velocity, this approach can take the place of or supplement the capabilities of an optomechanical scanner.

In the embodiments that are described below, an optoelectronic device comprises an array of optical transceiver cells, which comprise respective optical transducers for coupling optical radiation between the transceiver cells and a target. The optical transducers define the respective optical apertures of the transceiver cells. Projection optics project the optical apertures onto respective fields of view on the target.

A tunable radiation source outputs coherent radiation while tuning the wavelength of the coherent radiation over a selected range. An optical distribution network conveys the coherent radiation from the radiation source to the optical transceiver cells for transmission via the optical transducers toward the target. The projection optics comprise a dispersive element, which shifts the fields of view of the transceiver cells across the target in response to the scanning of the wavelength. Thus, each transceiver cell will probe a range of locations on the target as the wavelength scans.

In the embodiments that are described hereinbelow, prisms are presented as examples of dispersive elements. Alternatively, in all embodiments, other dispersive elements may be used, can be used such as gratings, grating prisms, and arrangements of multiple gratings and/or prisms to enhance the scan amplitude as a function of wavelength.

By judicious combination of the geometry of the array and the geometrical scan paths generated by wavelength tuning of the radiation source, the target can be probed densely. The scan density may be uniform, or it may be varied over different areas of the target, for example by controlling the tuning characteristics of the radiation source. Wavelength tuning can be used on its own, so that the target is scanned without any use of moving parts; or alternatively, it may be combined with optomechanical scanning in order to increase the scanning range and versatility.

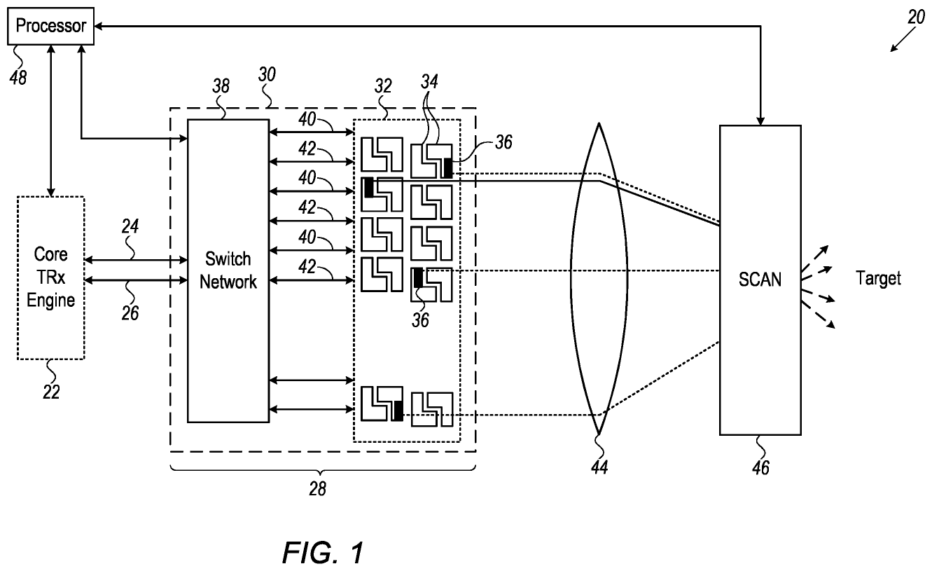

FIG. 1 is a block diagram that schematically illustrates an optical sensing system 20, in accordance with an embodiment of the invention.

In system 20, a core TRx engine 22 comprises one or more laser light sources, along with photonic and electronic circuit components for control, modulation, and distribution of the coherent radiation generated by the light sources. Specifically, in the embodiments that are described below, the laser light source or light sources are tunable, and the optical radiation that they output can be tuned across a selected range of wavelengths. TRx engine 22 is connected by one or more optical waveguides 24, and possibly also an electrical bus 26, to an optoelectronic sensing device 28, which is formed on a substrate 30.

Additionally or alternatively, TRx engine 22 can implement a variety of different modulation schemes, such as amplitude modulation, frequency modulation and/or phase modulation, including chirped modulation for use in frequency-modulated continuous wave (FMCW) LiDAR and pseudo-random phase modulation for use in phase-modulated continuous wave (PMCW) LiDAR. The modulation may be applied by controlling the drive current supplied to the laser or lasers. Further alternatively or additionally, TRx engine 22 may include features, such as a controllable gain medium or gratings, that can be used to modulate the outgoing light in response to electrical signals. As another alternative, the modulation may be applied externally, for example by optical modulation of the laser beam.

In the embodiments described below, device 28 is fabricated using photonic integrated circuit (PIC) technology, and substrate 30 comprises a silicon die, for example in a silicon on insulator (SOI) configuration. Alternatively, substrate 30 may comprise other sorts of semiconductor or dielectric materials. Core TRx engine 22 may be disposed on substrate 30, as well, in which cases waveguides 24 and bus 26 may conveniently be formed on substrate 30, for example by photolithographic processes. Alternatively, core TRx engine 22 may be coupled to substrate 30 via one or more edge couplers or one or more grating couplers (not shown). Further alternatively, waveguides 24 and bus 26 may comprise optical fibers and conductive wires, respectively.

Device 28 comprises an array 32 of sensing cells 34 formed on substrate 30. Each sensing cell 34 comprises an optical transducer 36, which couples light in and out of the cell, along with photonic and electronic components, as shown in detail in the figures that follow. Sensing cells 34 may all be of the same type, or alternatively, device 28 may include two or more different types of sensing cells. In some embodiments, sensing cells 34 comprise transceiver (TRx) cells, including photonic components for both transmission and reception of light; and in this case, transducers 36 both transmit light toward a target and receive light reflected from the target. Alternatively or additionally, sensing cells 34 may comprise only receiving components, which receive light reflected from a target following transmission of the light through other channels (not shown).

Sensing cells 34 have respective fields of view, which are defined by the respective optical apertures of optical transducers 36 and by focusing optics 44, which project the optical apertures onto a target. Each transducer 36 emits (and receives) a cone of light that is collimated by optics 44, and the resulting beam from each transducer is projected into a different angle in the field of view. A scanning device 46 scans the fields of view over the target. In the present embodiment, scanning device 46 comprises a dispersive element, such as a prism or a diffraction grating (either reflective or transmissive), which operates in conjunction with focusing optics 44 and with the wavelength tuning of core TRx engine 22 to shift the fields of view defined by optical transducers 36 over the target. This functionality is described and illustrated further with reference to the figures that follow. In addition, scanning device 46 may include an optomechanical scanner. Scanning device 46 may scan the beams output by transducers 36 to control the density of coverage of the field of view of system 20, including varying the density of coverage in different areas of the field. In this manner, even when the fields of view of transducers themselves cover the target only sparsely, the density of coverage will be filled in as desired over the entire target of areas of interest within the target.

A switch network 38 on substrate 30 acts as an optical distribution network, to distribute light received through waveguides 24 among multiple optical buses 40, which comprise waveguides coupled to deliver the light to different, respective sets of sensing cells 34. Switch network 38 also couples electrical signals between electrical bus 26 and electrical buses 42, for transfer of the electrical signals to and from sensing cells 34. Switch network 38 typically comprises an optical distribution tree, made up of waveguides formed on substrate 30. Switch network 38 may be configured as an active optical network, comprising optoelectronic components that select the buses 40 to which the light is to be distributed. Alternatively or additionally, switch network 38 may comprise a passive optical splitter array.

The use of active optical switching adds complexity to device 28 but enables the optical energy provided through waveguides 24 to be distributed selectively among sensing cells 34. This sort of active, switched network can be used to select individual sensing cells or groups of sensing cells to be activated in scanning over a target. As scanning device 46 scans the fields of view of sensing cells 34 over the target, the optical apertures of optical transducers 36 define respective scan lines extending along the scan direction of the scanner. A controller (such as a processor 48) can actuate the switches in switch network 38 so as to select the scan lines to be probed by device 28. In this manner, for example, certain rows of a raster scan can be selected for sensing in different areas of the target; and the spacing between raster rows can be varied depending on the desired resolution. Thus, the available optical energy can be concentrated in the sensing cells in locations corresponding to regions of interest in the target.

To summarize, the scheme shown generally in FIG. 1 enables a flexible choice of scanning characteristics and scan pattern by appropriate choices of the geometrical layout of array 32, scanning of the fields of view of sensing cells 34 by optics 44 and scanning device 46, and switch network 38. The operation of system 20 can thus be controlled in both the spatial and temporal dimensions to enrich the information content of the projected and received images. A given spatial location can receive information from several different modalities, multiplexed by temporal scanning. In addition, scanning in any one dimension effectively projects points along the other dimension along the temporal axis, and thus opens up possibilities of spatio-temporal multiplexing with enriched collection of information as a result. Furthermore, the interplay between fast switching (optical and/or electrical) by switch network 38 and the scanning modalities described above creates additional scanning possibilities, such as varying the dwell time on the target dynamically as needed, as well as adaptive control of resolution and frame rate and configurable definition of regions of interest.

Processor 48 controls the operation of system 20 and receives signals output by sensing cells 34 in response to light received by device 28. Processor 48 typically comprises a general-purpose microprocessor, with suitable analog and digital interfaces for controlling and receiving signals from the components of system 20. Alternatively or additionally, processor 48 may comprise special-purpose digital logic and other hardware components, which may be hard-wired or programmable. Processor 48 processes the signals output by sensing cells 34 in order to reconstruct features of the target. For example, processor 48 may generate a depth map of the target using techniques of optical coherence tomograph (OCT) for short-range targets or CW LiDAR for longer-range targets.

In some embodiments, processor 48 actuates sensing cells 34 selectively, i.e., the processor receives signals from different sensing cells in different sweeps of scanning device 46 or even during a single sweep. As noted earlier, when switch network 38 comprises an active optical network, it can be controlled in this context to direct the light from core TRx engine 22 to the sensing cells that are active at any given instant and thus use the available optical power more efficiently. By selective activation of sensing cells 34, processor 48 can vary the resolution of a scan and/or concentrate sensing resources in a certain region of interest of the target.

Additionally or alternatively, processor 48 can control parameters including the range and speed of scanning device 46, the intensity of the beams transmitted toward target, and the integration time of sensing cells 34 in order to adjust the range, resolution, and SNR of any given scan. Specifically, in the present embodiments, processor 48 can control the range and speed of wavelength tuning by core TRx engine 22, which will in turn control the distance and speed at which the dispersive element in scanning device 46 shifts the fields of view of sensing cells 34 across the target. Details of this functionality are described further hereinbelow with reference to the figures that follow.

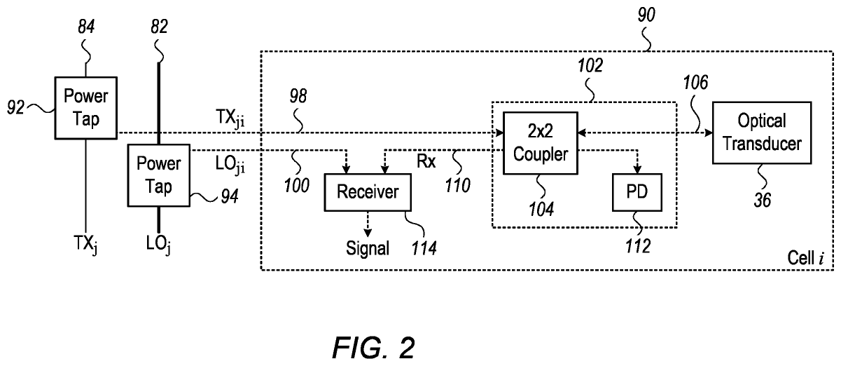

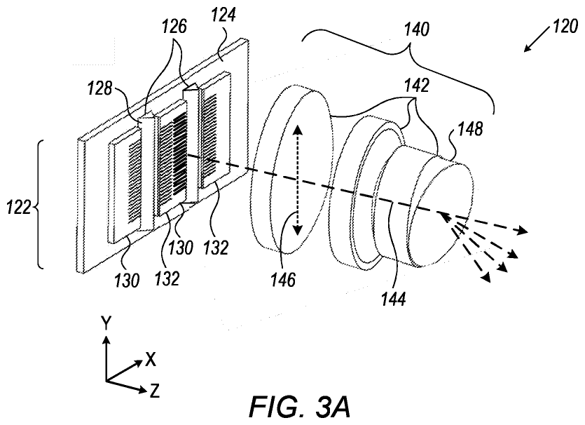

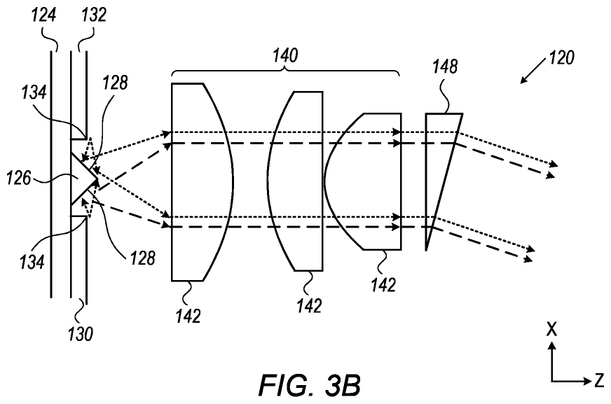

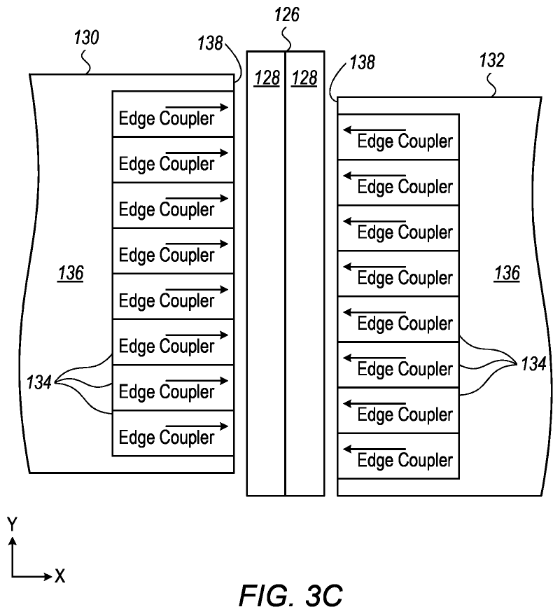

FIG. 2 is a block diagram that schematically shows details of optical transceiver cell 90, in accordance with an embodiment of the invention. Transceiver cell 90 may be used in place of sensing cells 34 in FIG. 1. Alternatively, other transceiver cell designs, such as those shown in FIGS. 3, 6-9, and 11 of the above-mentioned PCT Patent Application PCT/US2022/40527 may be used in the devices and systems described herein.

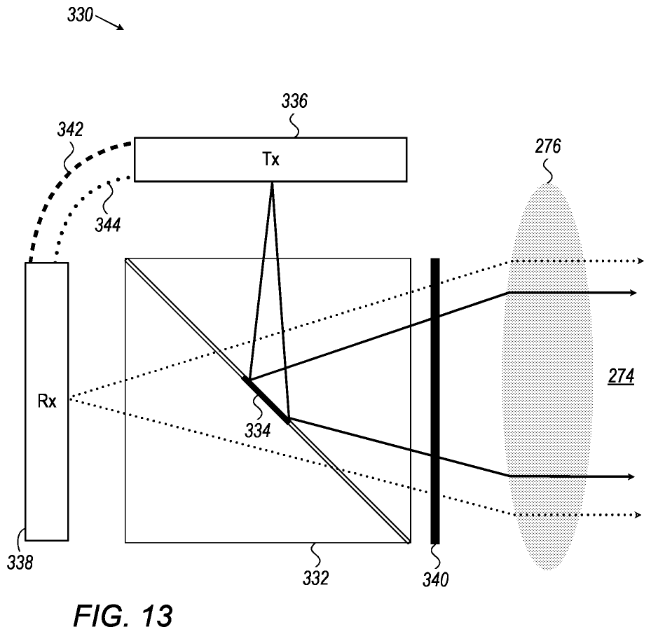

Cell 90 comprises a pair of taps 92 and 94, which extract respective portions of the coherent radiation propagating in buses 84 and 82 for input to a transmit waveguide 98 and a LO waveguide 100, respectively. Alternatively, both transmit waveguide 98 and LO waveguide 100 may receive the Tx and LO beams, respectively, from the same optical bus; or cell 90 may comprise a single tap to bus 84, with an internal splitter (not shown) to split off a small part of the Tx beam to serve as the LO beam. A photonic circuit 102 in cell 90 comprises a coupler 104, which passes the outgoing coherent radiation via a waveguide 106 to optical transducer 36 for transmission toward the target. Transducer 36 may comprise a grating coupler or edge coupler, for example, such as the types of transducers shown in FIGS. 13-19 and 20A-C of PCT Patent Application PCT/US2022/40527.

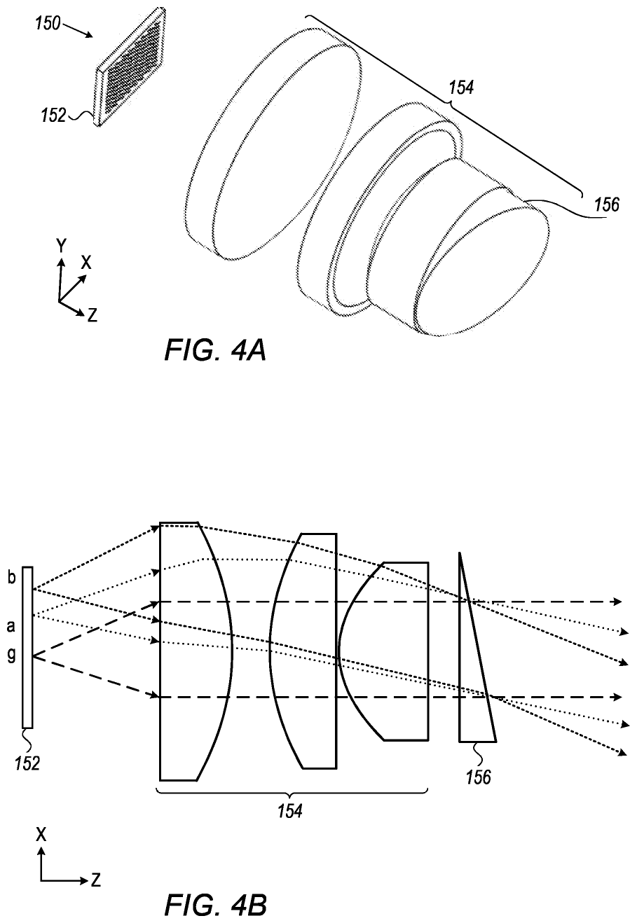

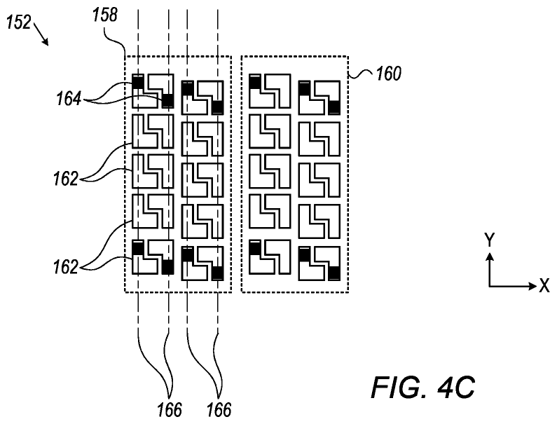

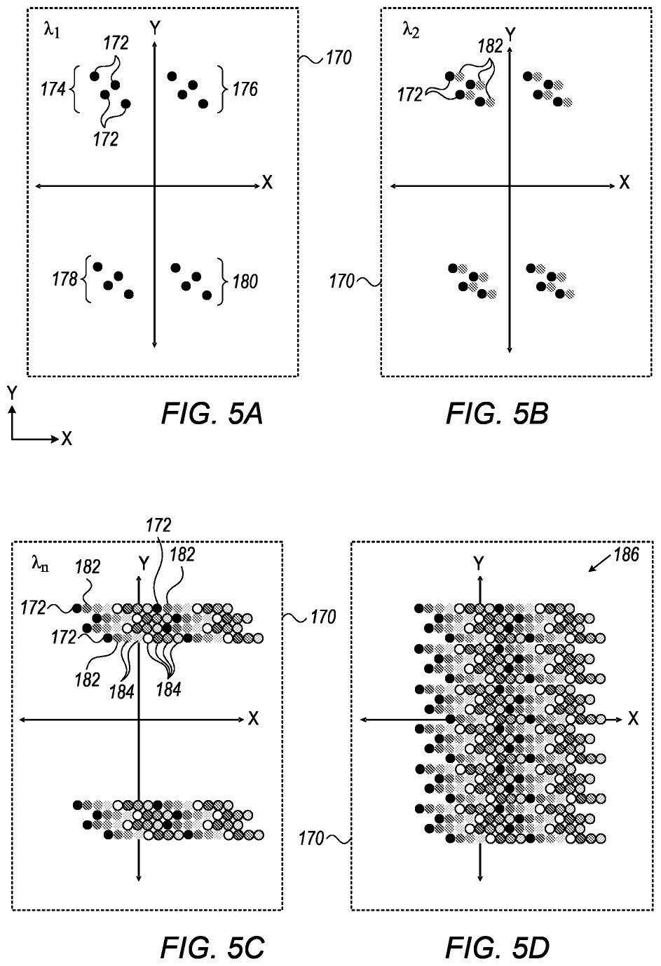

Transducer 36 also receives incoming radiation from the target and conveys the incoming radiation via waveguide 106 and coupler 104 to a receive waveguide 110. Transducer 36 may comprise a polarization beamsplitter rotator (PBSR, not shown), to enable cell 90 to receive and process incoming radiation of both polarizations. A receiver 114 mixes the coherent radiation from LO waveguide 100 with the incoming radiation received via coupler 104 through receive waveguide 110 and generates a corresponding electrical output signal. Receiver 114 typically comprises a mixer, such as a 2×2 optical coupler, or a pair of mixers in an optical hybrid, along with a suitable detector or detectors, such as a balanced pair of photodiodes (not shown in the figures), for example as shown in FIGS. 4 and 5 of PCT Patent Application PCT/US2022/40527. Assuming the coherent beams carried by buses 82 and 84 to be suitably modulated, for example with a frequency chirp, the electrical output signal will comprise a beat frequency indicative of the range and velocity of the target.

Coupler 104 may comprise a directional coupler or a beamsplitting coupler, such as a polarization beamsplitter rotator (PBSR). A photodiode 112 may be attached to a beamplitting coupler for termination and monitoring. The beamsplitting coupler may be a balanced 50/50 coupler, or it may alternatively be unbalanced, for example an 80/20 coupler, which conveys only 20% of the energy in the Tx beam toward transducer 36, while conveying 80% of the incoming radiation to receive waveguide 110. This sort of configuration is useful in applications in which there are limits (such as safety limits) on the optical power projected toward the target.

Reference is now made to FIGS. 3A, 3B and 3C, which schematically illustrate an optical sensing system 120, in accordance with an embodiment of the invention. FIG. 3A is a pictorial view of optical sensing system 120, while FIG. 3B is a sectional view of the optical sensing system. FIG. 3C is a schematic frontal view showing details of a coupling arrangement used in optical sensing system 120.

System 120 comprises a sensing subassembly 122, comprising a carrier substrate 124, with one or more dual folding mirrors 126 mounted on the carrier substrate. Dual folding mirror 126 comprises a pair of reflecting surfaces 128 disposed at opposite angles relative to a normal to carrier substrate 124. In the pictured embodiments, dual folding mirror 126 has a triangular profile, with reflecting surfaces 128 oriented respectively at +45° and −45° relative to the normal, which is parallel to the Z-axis in the coordinate system shown in the figure. Although subassembly 122 is shown in FIG. 3A to comprise two dual folding mirrors 126 with associated sensing devices 130, 132, in alternative embodiments, the sensing subassembly may comprise only a single dual folding mirror and associated sensing devices; or it may comprise three or more dual folding mirrors and sensing devices.

Alternatively, other sorts of folding mirrors may be used. For example, the folding mirrors may comprise only a single reflecting surface. Additionally or alternatively, the folding mirrors may be formed in the substrate, for example by techniques of 3D printing or imprint lithography. Furthermore, although the present embodiment uses edge couplers with folding mirrors, the principles of this and other embodiments may be implemented, mutatis mutandis, using other sorts of couplers, such as grating couplers. Similarly, embodiments that are described herein as comprising grating couplers may be modified, as appropriate, to use edge couplers instead.

Sensing subassembly 122 comprises a pair of sensing devices 130 and 132 mounted on carrier substrate 124 on opposing sides of dual folding mirror 126. Each sensing device 130, 132 comprises a planar device substrate 136, which is mounted on carrier substrate 124 such that an edge of device substrate 136 is in proximity to a corresponding reflecting surface 128 of dual folding mirror 126. Each sensing device 130, 132 comprises a respective array of transceiver cells formed on the corresponding device substrate 136, along with an optical distribution network, which distributes coherent radiation among the transceiver cells from a tunable radiation source, as described above.

The transceiver cells in devices 130 and 132 comprise optical transducers in the form of respective edge couplers 134, which are arrayed along an edge 138 of device substrate 136 so as to couple optical radiation between the cells and the proximate reflecting surface 128. (Although edges 138 are shown in the figures as exterior edges of the substrates, in alternative embodiments, edge couplers 134 may be arrayed along an interior edge, such as the edge of a trench in the substrate; and references to “edges” of the substrate in the present description and the claims should be understood as referring to both exterior and interior edges unless the context implies otherwise.) Edges 138 are both parallel to the Y-axis, as is the longitudinal axis of dual folding mirror 126. Edge couplers 134 have a certain pitch, i.e., the center-to-center distance between adjacent edge couplers along the Y-axis, which is limited by the constraints of the PIC technology that is used to produce devices 130 and 132. To increase the scan density, edge couplers 134 can be staggered, i.e., edge couplers 134 in device 132 can be offset along the Y-axis by half the pitch relative to edge couplers 134 in device 130, as shown in FIG. 3C.

Edge couplers 134 define the respective optical apertures of the transceiver cells in the arrays on devices 130 and 132. Imaging optics 140, comprising one or more optical elements 142, image these optical apertures along an optical axis 144 onto the target, thus defining the respective field of view of each transceiver cell. A dispersive element, such as a prism 148, deflects the optical radiation transmitted by the transceiver cells, with the deflection angle varying as a function of the wavelength of the radiation. Thus, as the wavelength of the radiation is tuned, prism 148 scans the fields of view of the sensing elements across the target. Alternatively, other sorts of dispersive elements may be used, such as a suitable diffraction grating or holographic element.

In addition to wavelength-based dispersive scanning by prism 148, system 120 may also comprise an optomechanical scanner, such as a rotating mirror (not shown), which scans the imaged optical apertures across the target. Additionally or alternatively, the scanner in system 120 may operate by shifting at least one of optical elements 142 and/or shifting carrier substrate 124 in a direction transverse to optical axis 144, for example as represented in FIGS. 3A by an arrow 146. This shift parallel to the Y-axis in the pictured embodiment, and will accordingly shift the fields of view of the transceiver cells in the Y-direction, while prism 148 scans the fields of view of the transceiver cells along the X-axis as the wavelength changes. Alternatively, both mechanical shift and dispersive shift can be in the same direction (e.g. X), thereby increasing the resulting shift amplitude. Further alternatively, system 120 may operate on the basis of dispersive scanning alone, without optomechanical scanning.

In some embodiments of the present invention, processor 48 (FIG. 1) controls the optical switching network and other capabilities of the transceiver device scanning a target selectively, to identify and extract detailed information with respect to regions of interest. For example, to make optimal use of the available sensing and processing resources, the fields of view of the transceiver cells may first be scanned across a target area at a certain (typically coarse) resolution, and the signals output by the transceiver cells are processed to identify a region of interest within the target area. Specific techniques for selecting and scanning the region of interest and enhancing the quality of 3D mapping in the region are described in greater detail in the above-mentioned PCT Patent Application PCT/US2022/40527, for example in reference to FIG. 34.

Reference is now made to FIGS. 4A, 4B and 4C, which schematically illustrate an optical sensing system 150, in accordance with another embodiment of the invention. FIG. 4A is a pictorial view of optical sensing system 150, while FIG. 4B is a sectional view of the optical sensing system. FIG. 4C is a schematic frontal view showing details of an optical transceiver array 152 used in optical sensing system 150.

System 150 comprises an array 152 of optical transceiver cells 162, which transmit coherent radiation that they receive through an optical distribution network from a tunable radiation source (as shown in system 20 in FIG. 1, for example). Projection optics 154 project the optical apertures of transceiver cells through a prism 156 toward a target. As in the preceding embodiments, tuning the wavelength of the coherent radiation causes the fields of view of the transceiver cells to shift across the target.

As shown in FIG. 4C, transceiver cells 162 comprise respective grating couplers 164, which serve as optical transducers and define the respective optical apertures of the transceiver cells. Typically, all of transceiver cells 162 contain respective grating couplers; but only a small number of the grating couplers are shown in FIG. 4C for the sake of simplicity. Grating couplers 164 are arranged along parallel rows 166, running along the Y-direction. (The terms “rows” and “columns” are used interchangeably in the present description and in the claims, and the directions of the Cartesian axes are chosen arbitrarily.) The dispersion of prism 156 causes the fields of view defined by grating couplers 164 to shift along the X-direction as the wavelength is tuned. In other words, the wavelength-based scan direction is perpendicular to rows 166. Alternatively, any suitable arrangement of grating couplers may be used and combined with a corresponding scan pattern to cover the target to the desired density.

In the example shown in FIG. 4C, transceiver cells 162 are arranged in modules 158, 160. (Although only two such modules are shown in the figure, with twenty transceiver cells in each module, in practice array 152 typically comprises a larger number of modules, with a larger number of transceiver cells in each module.) Rows 166 are separated by a certain horizontal pitch along the X-axis; and grating couplers 164 in each row 166 within each module 158, 160 are offset along the Y-axis by a certain vertical pitch relative to the grating couplers in the other rows.

FIGS. 5A, 5B, 5C and 5D are schematic frontal views of scan patterns projected onto a target 170 by system 150 (FIGS. 4A-4C) as the wavelength of the radiation source is tuned, in accordance with an embodiment of the invention. For the sake of simplicity, FIGS. 5A, 5B and 5C show only groups 174, 176, 178 and 180 of fields of view 172 of grating couplers 164 that are marked in FIG. 4C. The remaining fields of view are shown in FIG. 5D.

FIG. 5A shows the positions of fields of view 172 while system 150 transmits coherent radiation at an initial wavelength λ₁. The fields of view are separated along the X-axis by the row pitch and along the Y-axis by the vertical offset noted above. In FIG. 5B, the wavelength is tuned to a new value λ₂, leading to shifted fields of view 182 due to the dispersion of prism 156. Continuing to scan through wavelengths λ₃, λ₄. . . λₙ gives rise to further shifted fields of view 184, as shown in FIG. 5C, filling in the entire gaps between groups 174 and 176 and between groups 178 and 180.

FIG. 5D shows a scan pattern 186 generated when wavelength tuning is applied to all of transceiver cells 162 in array 152 (FIG. 4C). By proper selection of the range and rate of wavelength tuning, target 170 can be covered with substantially any desired scan density, without requiring any mechanical motion at all of the elements of system 150.

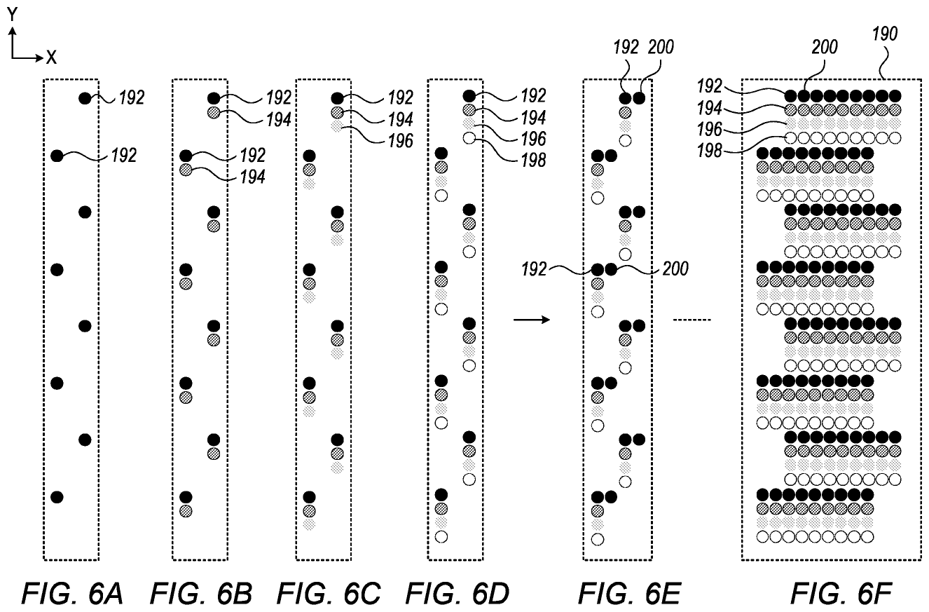

FIGS. 6A, 6B, 6C, 6D, 6E and 6F are schematic frontal views of scan patterns projected onto a target 190 by a modified version of system 120 (FIGS. 3A-3C) as the wavelength of the radiation source is tuned, in accordance with an embodiment of the invention. In this embodiment, prism 148 is rotated by 90° relative to its orientation in FIG. 3A, so that tuning the wavelength of the radiation source will scan the fields of view of edge couplers 134 in the Y-direction. An optomechanical scanning element, such as a rotating mirror or translation of optics 140, scans the fields of view in the X-direction.

FIG. 6A shows the positions of fields of view 192 while system 120 transmits coherent radiation at an initial wavelength. The fields of view are separated along the Y-axis by the pitch of edge couplers 134 and along the X-axis by the offset reflecting surfaces 128. In FIGS. 6B-6D, the wavelength is tuned to new values, leading to shifted fields of view 194, 196, 198 due to the dispersion of prism 148. The set of fields of view 192, 194, 196, 198 fills the gaps between the locations of edge couplers 134.

In FIG. 6E, the optomechanical scanning element is incremented in the X-direction, and the wavelength is tuned back to its original value, giving rise to shifted fields of view 200. Tuning the wavelength with the scanning element in this location will again fill in the vertical gap between the edge coupler locations. This process continues until the scan is completed, as shown in FIG. 6F. By virtue of the wavelength-based scanning in the Y-direction, the resolution of detection in this direction is substantially finer than the pitch of the transceiver array.

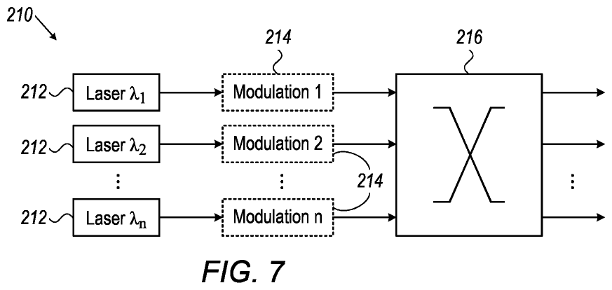

FIG. 7 is a block diagram that schematically illustrates a multi-wavelength core transceiver engine 210, in accordance with an embodiment of the invention. Core transceiver engine 210 outputs coherent radiation at multiple wavelengths simultaneously and may be used, for example, as the source of coherent radiation for any of sensing systems 20, 120 or 150, as described above.

In the present embodiment, engine 210 comprises multiple lasers 212, which output coherent radiation at different, respective wavelengths. For the purposes of some sensing applications, such as CW LiDAR, the beams output by lasers 212 may be modulated by respective frequency or phase modulators 214. Alternatively, lasers 212 may be modulated directly, in which case external modulators 214 may not be required. One or more optical switches 216 in the optical distribution network direct the coherent radiation at each of the multiple wavelengths to a different, respective set of the transceiver cells. The dispersive element in the sensing system, such as prism 148 or 156, will shift the fields of view of the transceiver cells at each of the multiple wavelengths by a different, respective angular shift.

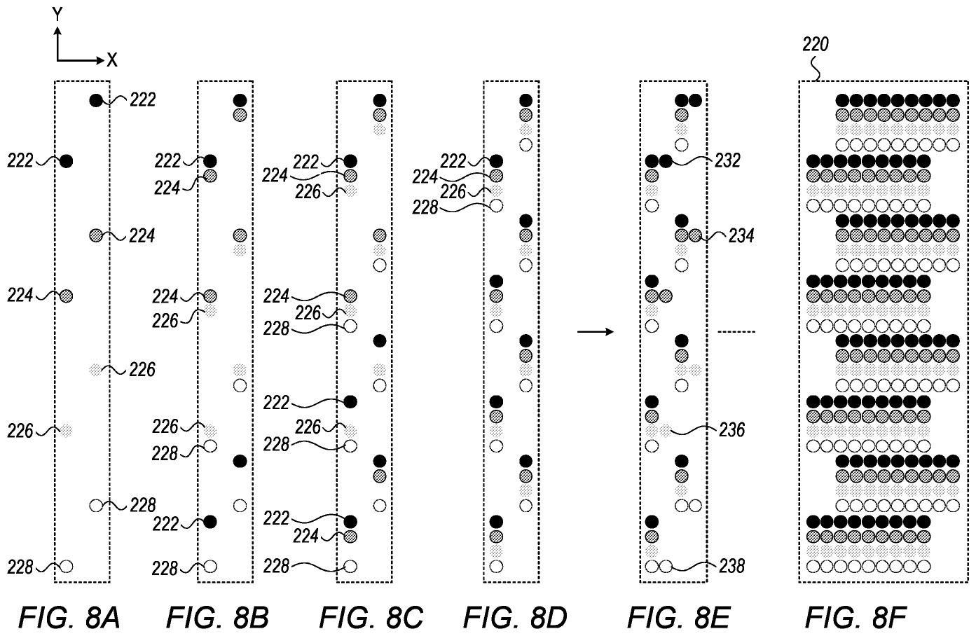

FIGS. 8A, 8B, 8C, 8D, 8E and 8F are schematic frontal views of scan patterns projected onto a target 220 using the multi-wavelength capabilities of core transceiver engine 210, in accordance with an embodiment of the invention. The present embodiment uses the same modified version of system 120 (FIGS. 3A-3C) as in the embodiments of FIGS. 6A-6F, with prism 148 rotated by 90° relative to its orientation in FIG. 3A, so that changing the wavelength of the radiation applied to edge couplers 134 will scan the respective fields of view of in the Y-direction. An optomechanical scanning element, such as a rotating mirror or translation of optics 140, scans the fields of view in the X-direction. Optical switches 216 cycle the multiple wavelengths λ₁, λ₂, λ₃, λ₄ of lasers 212 through different sets of the transceiver cells, so that each of the transceiver cells receives and transmits the coherent radiation at two or more different wavelengths at different, respective times during the scan.

FIG. 8A shows the positions of fields of view 222, 224, 226, 228 of edge couplers 134, each of which receives a different wavelength λ₁, λ₂, λ₃, λ₄ from optical switches 216 and outputs the radiation toward target 220. Prism 148 applies a different, wavelength-dependent deflection to each output beam. In FIGS. 8B-8D, switches 216 rotate the wavelengths among the transceiver cells, leading to different shifts of the fields of view due to the different wavelengths and the dispersion of prism 148. The set of fields of view 222, 224, 226, 228 fills the gaps between the locations of edge couplers 134, as shown in FIG. 8D.

In FIG. 8E, the optomechanical scanning element is incremented in the X-direction, and switches 216 rotate the wavelengths back to their original value, giving rise to shifted fields of view 232, 234, 236, 238. Switching the wavelengths with the scanning element in this location will again fill in the vertical gap between the edge coupler locations. This process continues until the scan is completed, as shown in FIG. 8F. Again, by virtue of the wavelength switching, the resolution of detection in the Y-direction is substantially finer than the pitch of the transceiver array.

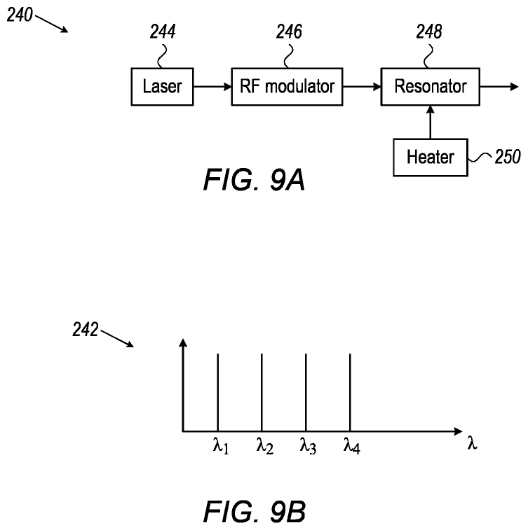

Reference is now made to FIGS. 9A and 9B, which schematically illustrate the operation of a multi-wavelength core transceiver engine 240, in accordance with another embodiment of the invention. FIG. 9A is a block diagram showing elements of the core transceiver engine, while FIG. 9B is a spectral plot showing a frequency comb 242 generated by engine 240. Frequency comb 242 comprises coherent radiation at multiple wavelengths, which are generated and output simultaneously. Core transceiver engine 240 may be used, for example, as the source of coherent radiation for any of sensing systems 20, 120 or 150, as described above.

To generate frequency comb 242, a laser 244 generates a beam of coherent radiation with narrow linewidth. An RF modulator 246 applies a frequency chirp to the laser beam. The chirped beam is input to a multi-frequency filter, for example a resonator 248 with high Q, which selects the comb of frequencies from the chirped beam. A heater 250 or other tuning element can be applied to adjust the length of resonator 248 and thus tune the wavelengths in comb 242. When comb 242 is distributed to the transceiver cells in an array, each cell will receive and transmit multiple wavelengths λ₁, λ₂, λ₃, λ₄. Semiconductor optical amplifiers (not shown) may be incorporated in the optical distribution network if needed to boost the optical power of the multi-wavelength beam. The dispersive element, such as prism 148 or 156, will deflect each wavelength at a different angle. Thus, each transceiver cell will probe multiple fields of view simultaneously.

To differentiate between the different wavelengths and angles in the reflected radiation received in the transceiver cells, the LO beam distributed among the cells (as shown in FIG. 2) may be modulated to create a comb at slightly different frequencies. Receiver 114 will then output beat signals at multiple frequencies simultaneously, each corresponding to one of the wavelengths in comb 242. The frequencies can be demodulated to separate out the signals according to the wavelengths and thus according to the respective field of view probed by each wavelength.

### Multi-Array Sensing Systems

In some applications, it is desirable to probe locations on a target using multiple arrays of transmitting and/or sensing cells. For example, in some cases it may be advantageous to use separate arrays of transmitting and receiving cells, rather than integrated arrays of transceiver cells as in the embodiments described above. As another example, it may be desirable to apply multiple optical sensing modalities to a target simultaneously, such as sensing in different spectral ranges or sensing different sorts of optical properties. The embodiments that are described hereinbelow address these needs using novel beamsplitting and beam-combining techniques.

The present embodiments provide optoelectronic devices comprising a beamsplitter, which comprises an optical surface that selectively reflects optical radiation having a certain optical property while selectively transmitting optical radiation having a different optical property. For example, the optical surface may be coated to serve as a polarization beamsplitter or a dichroic beamsplitter. First and second PICs, comprising arrays of optical cells, are disposed on respective first and second sides of the beamsplitter. The optical transducers of the optical cells in the first PIC couple optical radiation between the optical cells and a target by reflection from the optical surface, while those in the second PIC couple optical radiation between the corresponding optical cells and the target by transmission through the optical surface.

Various configurations of the PICs, optical cells, and optical transducers may be used in these embodiments. For example, the optical cells on both PICs may comprise transceiver cells, which both transmit coherent radiation via the respective optical transducers toward the target, receive the optical radiation from the target via the optical transducers, and output electrical signals in response to the received optical radiation, as in the embodiments described earlier. Alternatively, one of the PICs may comprise optical transmitter cells, which transmit coherent optical radiation toward a target, while the other PIC comprises optical receiver cells.

Different types of optical transducers may be used in these embodiments, as well. For example, in some embodiments, the optical transducers comprise grating couplers disposed on the surfaces of the PIC substrates. Alternatively, the optical transducers may comprise edge couplers disposed along the edges of the PIC substrates. Various sorts of optical arrangements, including lenses and scanning elements, for example, may be used to project the fields of view of the optical transducers onto a target and to scan the fields of view across the area of the target.

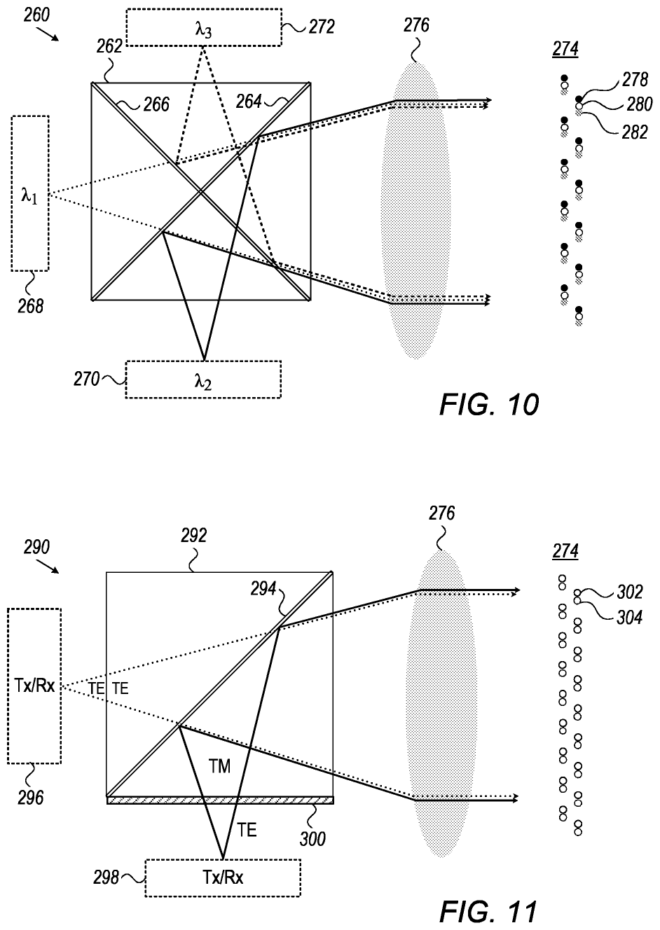

FIG. 10 is a schematic side view of an optoelectronic device 260 of this sort, in accordance with an embodiment of the invention. Device 260 comprises a beamsplitter 262 in the form of an “X-cube,” comprising two internal optical surfaces 264, 266. (In practice, these surfaces are each made up of two segments.) Surfaces 264 and 266 are wavelength-selective, meaning that they each selective reflect optical radiation in a certain wavelength range and transmit radiation in another wavelength range. Specifically, surface 264 reflects radiation in a range around a wavelength λ₂, while surface 266 reflects radiation in a different range around a wavelength λ₃. The remaining radiation, including a wavelength λ₁, is transmitted through both surfaces 264 and 266.

PICs 268, 270, and 272 are disposed on three difference sides of beamsplitter 262, so that each PIC can transmit and/or receive radiation in a corresponding wavelength range around λ₁, λ₂, or λ₃, respectively. PICs 268, 270 and 272 may conveniently be cemented to respective faces of beamsplitter 262. Alternatively, the PICS may be mounted at a small distance from the beamsplitter surfaces. As noted earlier, each of PICS 268, 270 and 272 comprises an array of optical cells including optical transducers, which optical radiation in the respective wavelength range between the optical cells and a target 274 via beamsplitter 262.

Projection optics 276 project fields of view 278, 280, 282 of the optical transducers in PICS 268, 270 and 272 onto target 274. The PICs may be aligned so that fields of view 278, 280, 282 overlap. In this case, each field of view will be probed by all the PICS, in all the respective wavelength ranges. Alternatively, fields of view 278, 280, 282 may be offset, so that they cover neighboring areas of target 274, as shown in FIG. 10, thus increasing the density of coverage.

FIG. 11 is a schematic side view of an optoelectronic device 290, in accordance with another embodiment of the invention. Device 290 comprises a polarization-selective beamsplitter 292, in which an optical surface 294 transmits optical radiation having a certain linear polarization, while reflecting optical radiation having the perpendicular linear polarization. PICs 296 and 298, comprising respective arrays of optical transceiver cells are mounted on or adjacent to respective faces of beamsplitter 292. As in the preceding embodiment, projection optics 276 project fields of view 302, 304 of the optical transducers in PICS 296 and 298 onto target 274.

Optical transducers, such as edge couplers and grating couplers, are often designed for coupling one linear polarization or the other. For example, in the present embodiment, it is assumed that the optical transducers and the waveguides in PICs 296 and 298 couple the TE polarization more efficiently than the TM polarization. In the pictured embodiment, optical surface 294 transmits TE radiation, which is well coupled to the optical transducers in PIC 296, while reflecting TM radiation. A half-wave rotator 300 is position between beamsplitter 292 and PIC 298 to rotate the incoming TM radiation that is reflected from surface 294 to the TE polarization, so that it can be coupled efficiently into PIC 298. Half-wave rotator 300 likewise rotates the outgoing TE radiation from PIC 298 to the TM polarization, which is reflected by surface 294.

Alternatively, the optical transducers in PIC 298 may be configured for efficient coupling of the TM polarization, so that half-wave rotator 300 is not needed. For example, the optical transducers in PIC 298 may each comprise a PBSR. Alternatively, when the optical transducers comprise grating couplers, the gratings in PIC 298 may be physically rotated by 90° relative to the gratings in PIC 296. In such embodiments, if the same core transceiver engine serves both PICs 296 and 298, PIC 296 may receive and process the TE reflections of the beams transmitted by the transmitters on both PICs, while PIC 298 receives and processes the TM reflections of the beams transmitted by the transmitters on both PICs.

Further alternatively, device 290 may be configured so that optical surface 294 transmits the TM polarization and reflects the TE polarization (for example by rotating PICs 296 and 298 by 90°). In this case, the solutions described above for coupling of the optical transducers in PIC 298 may instead be applied to PIC 296.

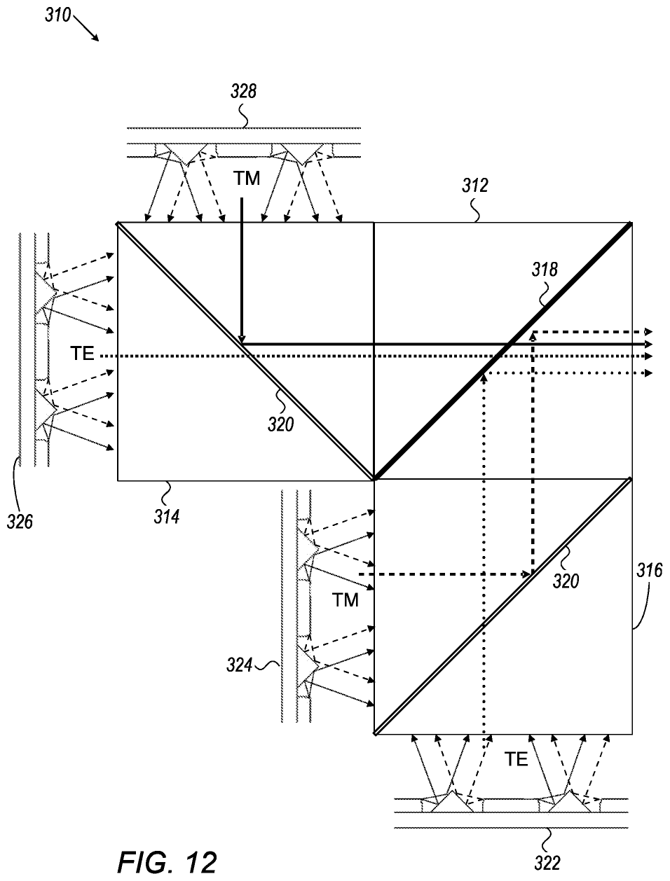

FIG. 12 is a schematic side view of an optoelectronic device 310, in accordance with yet another embodiment of the invention. Device 310 comprises three beamsplitter cubes 312, 314, 316, which are cemented together so as to combine the fields of view of the optical transducers in four PICs 322, 324, 326 and 328. This arrangement enables device 310 to probe a target with high density and high throughput. Alternatively or additionally, device 310 may be configured to apply two or more different sensing modalities to the target simultaneously.

Beamsplitter cube 312 comprises a wavelength-selective surface 318, for example a dichroic surface, which transmits optical radiation with wavelengths below a certain cutoff wavelength and reflects wavelengths above the cutoff wavelength. Beamsplitter cubes 314 and 316 comprise respective polarization-selective surfaces 320. PICs 322 and 326 thus receive and transmit optical radiation with TE polarization in the respective wavelength ranges, while PICs 324 and 328 receive and transmit optical radiation with TM polarization in the respective wavelength ranges. In the pictured example, the optical transducers in PICs 322, 324, 326 and 328 comprise edge-couplers with turning mirrors, but alternatively other types of optical transducers may be used.

FIG. 13 is a schematic side view of an optoelectronic device 330, in accordance with an alternative embodiment of the invention. In contrast to the previous embodiments, device comprises a separate transmitter PIC 336 and receiver PIC 338, which are positioned on different sides of a beamsplitter 332, with a polarization-selective surface 334. Thus, PIC 336 comprises optical transmitter cells, which transmit polarized coherent radiation, which reflects from surface 334 toward a target; while PIC 338 comprises optical receiver cells, which receive the optical radiation that is reflected from the target and is transmitted through surface 334. PICs 336 and 338 are typically interconnected by an optical bus 342 and an electronic bus 344, comprising suitable waveguides and wires.

In the pictured example, the transmitted beams from PIC 336 are focused to a narrow cone angle. Therefore, it is sufficient that a small, central area of surface 334 be coated to reflect the polarization of the transmitted beams. Outside this area, surface 334 may be uncoated, so that both linear polarizations pass through to be received by PIC 338. (Alternatively, if the transmitted cone is sufficiently narrow, the central area of surface 334 may simply have a reflective coating.)

Alternatively or additionally, a quarter-wave rotator 340 may be placed between beamsplitter 332 and target 274. As a result, transmitted radiation that is reflected back from target 274 without change of polarization will be transmitted efficiently through surface 334.

### Transceiver Arrays With Birefringent Beam Combiners

In most the embodiments that are described above, the optical transceiver cells have a single optical transducer for both transmission and reception, for example as shown in FIG. 2. This arrangement is advantageous in ensuring that the transmit and receive axes of the cells are precisely boresighted, but it comes at the expense of reduced optical efficiency due to coupling losses within the transceiver cell. The embodiment shown in FIG. 13 avoids this sort of coupling loss, but requires two separate PICS, which must be carefully aligned and synchronized.

Some embodiments of the present invention address this problem using arrays of optical transceiver cells with separate optical transducers for transmission and reception of optical radiation. A birefringent plate is used to align the transmit and receive axes precisely outside the PIC. The optical transducers may comprise either grating couplers or edge couplers, for example. The birefringent plate may advantageously comprise yttrium orthovanadate (YVO₄), but alternatively any other suitable birefringent material may be used.

Thus, in the present embodiments, an array of optical transceiver cells is formed on at least one substrate. Each transceiver cell comprises a first optical transducer configured to transmit outgoing optical radiation of a certain linear polarization along a transmit axis, and a second optical transducer configured to receive incoming optical beam of the perpendicular polarization along a receive axis, which is displaced transversely relative to the transmit axis. A birefringent plate is mounted with one side in proximity to the substrate so as to intercept the transmit and receive axes. The thickness and geometry of the birefringent plate are selected so as to deflect optical radiation of one of the two linear polarizations by an amount sufficient to align the axes of the outgoing and incoming optical radiation at the other side of the birefringent plate.

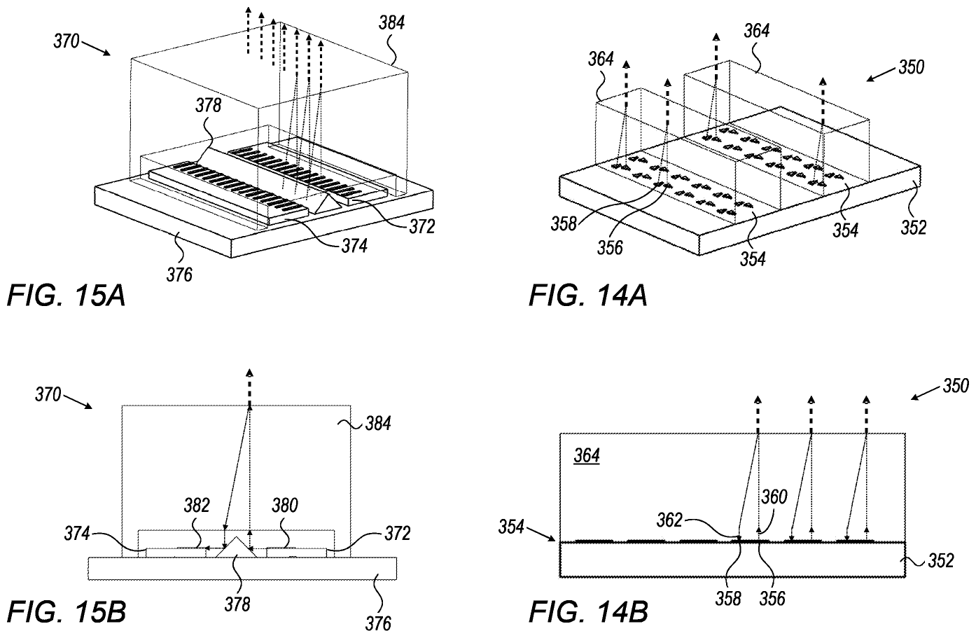

FIGS. 14A and 14B schematically illustrate an optoelectronic device 350 of this sort, in accordance with an embodiment of the invention. FIG. 14A is a pictorial view of device 350, while FIG. 14B is a sectional view.

Device 350 comprises a PIC substrate 352, on which multiple arrays 354 of transceiver cells are formed. Each cell comprise a pair of grating couplers with mutually perpendicular orientations, including a transmit coupler 356 and a receive coupler 358. Transmit coupler 356 transmits outgoing radiation of one polarization along a transmit axis 360, while receive coupler 358 receives incoming radiation of the perpendicular polarization along a receive axis 362. A birefringent plate 364, mounted with its lower side in contact with or proximity to couplers 356 and 358, deflects receive axes 362 so that axes 360 and 362 are aligned at the upper side of the plate.

FIGS. 15A and 15B schematically illustrate another optoelectronic device 370 of this sort, in accordance with an alternative embodiment of the invention. FIG. 15A is a pictorial view of device 370, while FIG. 15B is a sectional view.

Device 370 comprises arrays 372 and 374 of optical transmitters and receivers, mounted on a carrier substrate 376 on opposing sides of a folding mirror 378. Each pair of a transmitter in array 372 and the corresponding receiver in array 374 constitute a transceiver cell. Each such pair comprises a pair of edge couplers, including a transmit coupler 380 and a receive coupler 382, which are configured to couple optical radiation with respective linear polarizations that are mutually perpendicular. The transmit and receive axes of couplers 380 and 382 are both turned by mirror 378 away from substrate 376 and are offset transversely by the width of the mirror. A birefringent plate 384, mounted over arrays 372 and 374, deflects the receive axes so that they are aligned with the transmit axes at the upper side of the plate.

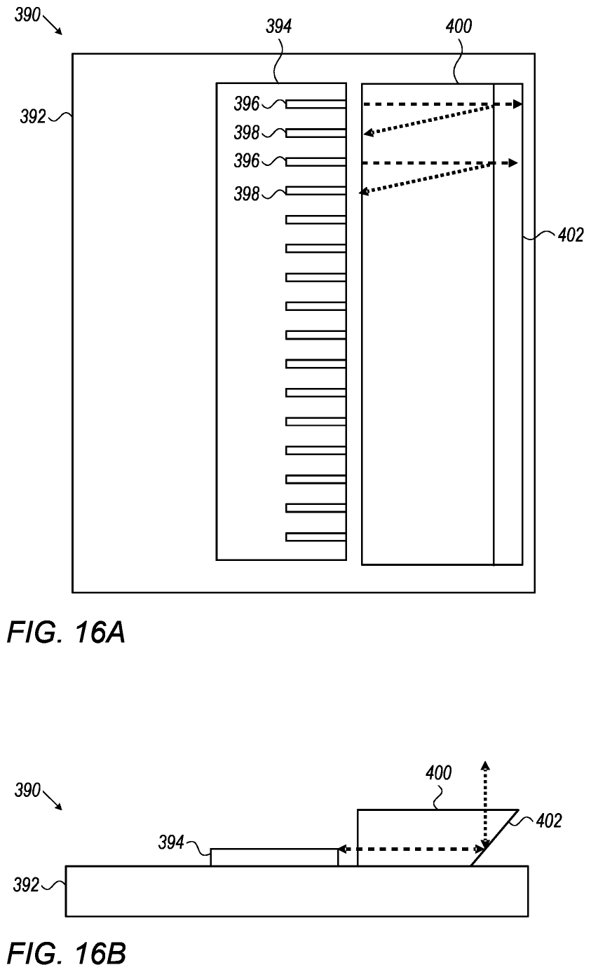

FIGS. 16A and 16B schematically illustrate an optoelectronic device 390, in accordance with a further embodiment of the invention. FIG. 16A is a top view of device 390, while FIG. 16B is a sectional view.

Device 390 comprises an array 394 of optical transceiver cells, mounted on a substrate 392. Each transceiver cell comprises a pair of edge couplers, including a transmit coupler 396 and a receive coupler 398, which are configured to couple optical radiation with respective linear polarizations that are mutually perpendicular. A birefringent plate 400, mounted on substrate 392 in proximity to couplers 396 and 398, deflects the receive axes so that they are aligned with the transmit axes at the opposite side of the plate. An internal reflecting surface 402 of plate 400 turns the axes in a direction perpendicular to substrate 392. Thus the same plate performs the functions of both the turning mirror and the birefringent plate that were used in the preceding embodiment.

### Multi-Modality PICs

In some of the preceding embodiments, multi-modality sensing and scanning of a target was achieved by combining the fields of view of multiple PICs using a beamsplitter. In other embodiments, however, multiple sensing modalities may be implemented using multiple different sorts of transceiver cells in a single PIC, together with a scanner, which scans the fields of view of the transceiver cells over a target so that each point on the target is sensed by transceiver cells using two or more different sensing modalities. Thus, for example, a scene may be scanned using both vertical and horizontal polarizations, in two or more different wavelength bands. This sort of multi-polarization, multi-spectral scanning is particularly useful, inter alia, in LiDAR applications, to achieve reliable depth mapping notwithstanding varying environmental conditions and different sorts of surfaces in the scene.

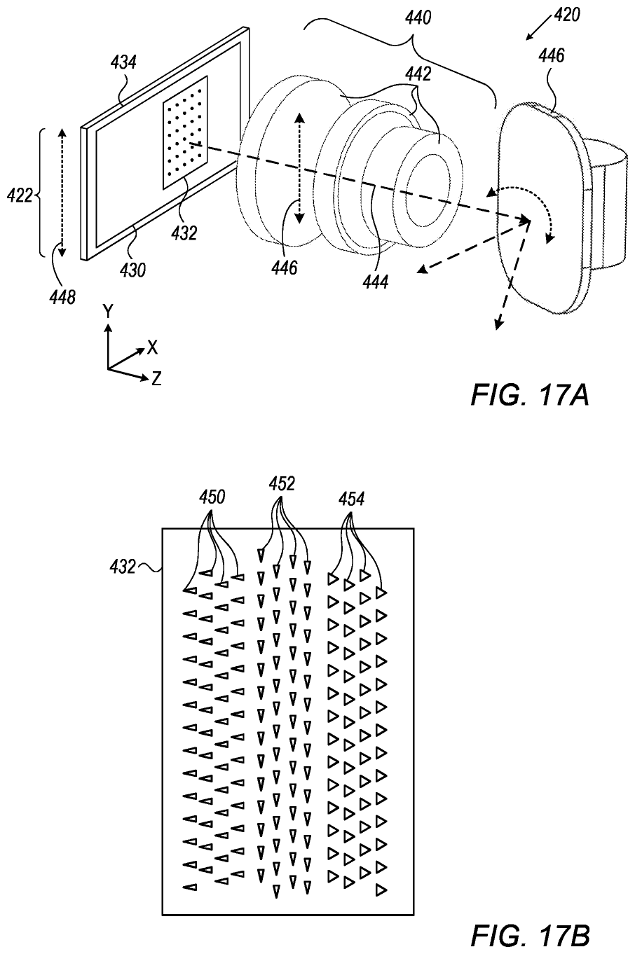

Reference is now made to FIGS. 17A and 17B, which schematically illustrate an optical sensing system 420, in accordance with an embodiment of the invention. FIG. 17A is a pictorial view of optical sensing system 420, while FIG. 17B is a schematic frontal view showing details of a transceiver array 432 used in optical sensing system 420.

System 420 comprises a sensing subassembly 422, comprising a carrier substrate 434, with a PIC 430 mounted on the carrier substrate. PIC 430 comprises transceiver array 432, together with ancillary components, such as a core transceiver engine and an optical distribution network, as described above. As shown in FIG. 17B, the transceiver cells in array 432 have different types of optical transducers 450, 452, 454, etc., which define the optical apertures of the corresponding transceiver cells. For example, the transceiver cells may be similar to transceiver cell 90, as shown in FIG. 2, and optical transducers 450, 452, 454, etc., may comprise grating couplers, which perform the function of optical transducer 36. Alternatively, other transceiver cell designs, such as those shown in FIGS. 3, 6-9, and 11 of the above-mentioned PCT Patent Application PCT/US2022/40527 may be used; and optical transducers 450, 452, 454 may comprise grating couplers or edge couplers, for example, such as those shown in FIGS. 13-19 and 20A-C of PCT Patent Application PCT/US2022/40527.

Each type of optical transducer in array 432 transmits and receives optical radiation having different characteristics from the other types of optical transducers. For example, as noted above, transducers 450 may sense optical radiation in a certain wavelength band with one linear polarization, while transducers 452 sense optical radiation in the same band with the orthogonal polarization. Transducers 454 may sense optical radiation in a different wavelength band. The associated transceiver cells and ancillary components may also be configured for different sensing functions, such as coherent or incoherent sensing in the same or different wavelength bands. Although optical transducers 450, 452, 454 in FIG. 17B are arranged in uniform grids in different, respective areas of array 432, the optical transducers may be arranged in different patterns, not necessarily uniform. Although array 432 in FIG. 17B contains roughly equal numbers of optical transducers of the different types in identical arrangements, the array may alternatively comprise different numbers and arrangements of the different types of optical transducers. Additionally or alternatively, the different types of optical transducers may be interleaved in array 432.

Imaging optics 440, comprising one or more optical elements 442, image these optical apertures along an optical axis 444 onto the target, thus defining the respective field of view of each transceiver cell. A scanner scans the fields of view of the sensing elements across the target. In the embodiment shown in FIG. 17A, the scanner comprises a rotating mirror 446, which scans the imaged optical apertures across the target. Rotating mirror 446 may comprise, for example, a single- or dual-axis galvanometer or MEMS (microelectromechanical systems) mirror assembly or a rotating polygonal mirror. Alternatively, other sorts of scanners, such as Risley prisms, may be used.

Additionally or alternatively, the scanner in system 420 may operate by shifting at least one of optical elements 442 and/or shifting carrier substrate 434 in a direction transverse to optical axis 444. The shift of one of optical elements 442 is represented in FIGS. 17A by an arrow 446, while the shift of carrier substrate 434 is represented by an arrow 448. Both shifts are parallel to the Y-axis in the pictured embodiment, and will accordingly shift the fields of view of the transceiver cells in the Y-direction, while rotating mirror 446 scans the fields of view of the transceiver cells along the X-axis.

However the scanner is implemented in system 420, it scans the optical apertures defined by optical transducers 450, 452, 454 across the target so that the optical apertures are projected successively onto respective sequences of multiple locations on the target. The scan pattern is typically chosen so that each location is probed in succession by two or more different types of optical transducers. Thus, each location on the target is probed in multiple modalities with substantially any desired scan density.

In some embodiments of the present invention, processor 48 (FIG. 1) controls the optical distribution network and other capabilities of PIC 430 to scan the target selectively, in order to identify and extract detailed information with respect to regions of interest. For example, to make optimal use of the available sensing and processing resources, the fields of view of the transceiver cells may first be scanned across a target area at a certain (typically coarse) resolution, and the signals output by the transceiver cells are processed to identify a region of interest within the target area. For example, processor 48 may identify shapes and ranges of objects in this first scan and select a region or regions contain objects of interest.

After identifying a region of interest in this manner, the fields of view of the transceiver cells are scanned selectively across the region of interest, typically with a resolution finer than the resolution of the first scan. The signals output by the transceiver cells during the high-resolution scan are processed in order to produce a high-quality three-dimensional (3D) map of the region of interest. Specific techniques for selecting and scanning the region of interest and enhancing the quality of 3D mapping in the region are described in greater detail in the above-mentioned PCT Patent Application PCT/US2022/40527 for example in reference to FIG. 34.

The various sorts of optoelectronic devices that have been described above may be readily integrated into the sorts of coherent optical sensing systems that are described in the above-mentioned PCT Patent Applications PCT/US2022/40526 and PCT/US2022/40527. Alternatively, features of the embodiments described herein may be applied in other applications of optical sensing arrays, as will be apparent to those skilled in the art after reading the present description. All such alternative implementations and applications are considered to be within the scope of the present invention.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optoelectronic device, comprising:
an array of optical transceiver cells comprising respective optical transducers configured to couple optical radiation between the transceiver cells and a target through respective optical apertures defined by the optical transducers;
a tunable radiation source, configured to output coherent radiation while tuning a wavelength of the coherent radiation over a selected range;
an optical distribution network, coupled to convey the coherent radiation from the radiation source to the optical transceiver cells for transmission via the optical transducers toward the target; and
projection optics, which are configured to project the optical apertures onto respective fields of view on the target, and which comprise a dispersive element, which shifts the fields of view across the target responsively to the tuning of the wavelength.

2. The device according to claim 1, and comprising a planar substrate, wherein the optical transceiver cells are disposed on the substrate, and the optical distribution network comprises multiple waveguides disposed on the substrate.

3. The device according to claim 2, wherein the optical distribution network comprises optical switches, and wherein the device comprises a controller, which is configured to actuate the switches so as to select different subsets of the optical transceiver cells that are to receive the coherent radiation from the waveguides.

4. The device according to claim 2, wherein the waveguides are configured as optical buses, and the optical transceiver cells comprise respective taps coupled to extract a portion of the coherent radiation propagating through the optical buses.

5. The device according to claim 2, wherein the optical transducers comprise grating couplers disposed on a surface of the substrate.

6. The device according to claim 2, wherein the optical transducers comprise edge couplers disposed along an edge of the substrate.

7. The device according to claim 1, wherein the optical transceiver cells comprise respective receivers, which are coupled to mix a part of the coherent radiation received from the optical distribution network with the optical radiation received from the target by the respective optical transducers and to output electrical signals responsively to the mixed radiation

8. The device according to claim 1, wherein the dispersive element comprises one or more dispersive elements selected from a set including prisms, gratings, grating prisms, and arrangements of multiple gratings and/or prisms.

9. The device according to claim 1, wherein the optical transducers are arranged along one or more parallel rows in the array, and wherein the dispersive element is configured to shift the fields of view in a scan direction perpendicular to the rows responsively to the scanning of the wavelength.

10. The device according to claim 1, wherein the dispersive element is configured to shift the fields of view across the target in a first direction responsively to the scanning of the wavelength, and wherein the device comprises an optomechanical scanner, which is configured to shift the fields of view across the target in a second direction, different from the first direction.

11. The device according to claim 1, wherein the tunable radiation source is configured to output the coherent radiation at multiple wavelengths simultaneously, whereby the dispersive element shifts the fields of view at each of the multiple wavelengths by a different, respective angular shift.

12. The device according to claim 11, wherein the optical distribution network comprises one or more optical switches, which are configured to direct the coherent radiation at the multiple wavelengths to different, respective sets of the transceiver cells.

13. The device according to claim 12, wherein the one or more optical switches are configured to cycle the multiple wavelengths through the sets of the transceiver cells so that each of the transceiver cells receives and transmits the coherent radiation at two or more different wavelengths at different, respective times.

14. The device according to claim 11, wherein the tunable radiation source comprises multiple laser sources, wherein each of the laser sources outputs a respective beam of the coherent radiation at a respective one of the multiple wavelengths.

15. The device according to claim 11, wherein the tunable radiation source is configured to generate a frequency comb comprising the multiple wavelengths in a single beam.

16-29. (canceled)

30. A method for optical sensing, comprising:
providing an array of optical transceiver cells comprising respective optical transducers configured to couple optical radiation between the transceiver cells and a target through respective optical apertures defined by the optical transducers;
conveying coherent radiation from a tunable source of coherent radiation via an optical distribution network to the optical transceiver cells for transmission via the optical transducers toward the target;
tuning a wavelength of the coherent radiation over a selected range; and
projecting the optical apertures onto respective fields of view on the target through a dispersive element, which shifts the fields of view across the target responsively to the tuning of the wavelength.

31. The method according to claim 30, wherein the optical transceiver cells are disposed on a planar substrate, and the optical distribution network comprises multiple waveguides disposed on the substrate.

32. The method according to claim 31, wherein the optical distribution network comprises optical switches, and wherein the method comprises actuating the switches so as to select different subsets of the optical transceiver cells that are to receive the coherent radiation from the waveguides.

33. The method according to claim 31, wherein the waveguides are configured as optical buses, and wherein conveying the coherent radiation comprises extracting a portion of the coherent radiation propagating through the optical buses through respective taps of the optical transceiver cells.

34. The method according to claim 31, wherein the optical transducers comprise grating couplers disposed on a surface of the substrate.

35. The method according to claim 31, wherein the optical transducers comprise edge couplers disposed along an edge of the substrate.

36. The method according to claim 30, and comprising mixing a part of the coherent radiation received in the optical transceiver cells from the optical distribution network with the optical radiation received from the target by the respective optical transducers, and outputting electrical signals from the optical transceiver cells responsively to the mixed radiation

37. The method according to claim 30, wherein the dispersive element comprises comprises one or more dispersive elements selected from a set including prisms, gratings, grating prisms, and arrangements of multiple gratings and/or prisms.

38. The method according to claim 30, wherein the optical transducers are arranged along one or more parallel rows in the array, and wherein the dispersive element shifts the fields of view in a scan direction perpendicular to the rows responsively to the scanning of the wavelength.

39. The method according to claim 30, wherein the dispersive element is configured to shift the fields of view across the target in a first direction responsively to the scanning of the wavelength, and wherein the method comprises optomechanically scanning the fields of view across the target in a second direction, different from the first direction.

40. The method according to claim 30, wherein conveying the coherent radiation comprises distributing the coherent radiation to the optical transceiver cells at multiple wavelengths simultaneously, whereby the dispersive element shifts the fields of view at each of the multiple wavelengths by a different, respective angular shift.

41. The method according to claim 40, wherein the optical distribution network comprises one or more optical switches, and the method comprises actuating the switches to direct the coherent radiation at the multiple wavelengths to different, respective sets of the transceiver cells.

42. The method according to claim 41, wherein actuating the switches comprises cycling the multiple wavelengths through the sets of the transceiver cells so that each of the transceiver cells receives and transmits the coherent radiation at two or more different wavelengths at different, respective times.

43. The method according to claim 40, wherein the tunable radiation source comprises multiple laser sources, wherein each of the laser sources outputs a respective beam of the coherent radiation at a respective one of the multiple wavelengths.

44. The method according to claim 40, wherein distributing the coherent radiation comprises generating a frequency comb comprising the multiple wavelengths in a single beam.

45-66. (canceled)
